(19) United States
(12) Patent Application Publication
(10) Pub. No.: US 2021/0341611 A1
(43) Pub. Date: Nov. 4, 2021

(54) LIDAR WITH DELAYED REFERENCE SIGNAL

(71) Applicant: Majid Boloorian, San Diego, CA (US)

(72) Inventor: Majid Boloorian, San Diego, CA (US)

(73) Assignee: SiLC Technologies, Inc., Monrovia, CA (US)

(21) Appl. No.: 16/866,437

(22) Filed: May 4, 2020

(51) Int. Cl. G01S 17/34; G01S 17/89; G01S 17/58

(52) U.S. Cl. CPC G01S 17/34; G01S 17/58; G01S 17/89

(57) ABSTRACT

Systems and methods described herein are directed to extending a range of operation of a remote imaging system including a Light Detection and Ranging (LIDAR) system. Example embodiments describe delaying a locally generated reference signal in time with respect to an outgoing LIDAR signal. By delaying the reference signal, the system can effectively increase a maximum range of target detection while maintaining the accuracy of target detection. In some embodiments, by delaying the reference signal, the system may be able to reduce the effects of phase noise and chirp non-linearities on the beat signal and effectively improve the signal-to-noise ratio. As such, the maximum range of operation of the system may be increased while maintaining highly accurate estimations of target depth and/or velocity.

### FIELD

The invention relates to remote imaging systems. In particular, the invention relates to frequency modulated continuous wave (FMCW) based LIDAR (Light Detection and Ranging) systems.

### BACKGROUND

With the rapidly increasing need for three-dimensional remote imaging systems across different industries, including robotics, machine vision, autonomous systems, and unmanned aerial vehicles, several technological improvements are needed in order to deliver improvements in imaging performance at reduced costs. For example, advanced driver assistance systems (ADAS) can benefit from long-range LIDAR (Light Detection and Ranging) systems that can provide sufficient time for processing a vehicle's environment and implementing emergency breaking measures, if necessary, by detecting objects across longer distances. However, operation of such imaging systems over long distances can be challenging due to signal quality issues and higher performance requirements from a LIDAR light source such as a laser. For example, LIDAR systems may be limited to an imaging range of less than 300 meters due to an increase in phase noise and/or signal non-linearities associated with received LIDAR signals that have been reflected from objects located further away. Round-trip travel time increases with an increase in distance over which a LIDAR signal needs to travel to and from a target object and correlation between the phase noise in the received LIDAR signal and a locally generated reference signal reduces with an increase in the round-trip travel time. As a result, the phase noise associated with the received LIDAR signal may not cancel out the phase noise associated with the reference signal during beat signal generation, thereby degrading the quality of the beat signal. Additionally, for LIDAR systems with a fixed data capture duration per data cycle, greater round-trip delays associated with the reflected LIDAR signals may reduce the portion of useable signal that falls within the data capture duration. The reduction in the useable signal portion can further hamper accurate LIDAR signal processing by worsening the effects associated with phase distortions and signal non-linearities in the reflected LIDAR signals. As such, there exists a need for LIDAR systems that can scan targets over longer ranges while minimizing the effects of signal distortions associated with the received LIDAR signals and providing accurate estimates of target distances and/or velocities.

### SUMMARY

This summary is not intended to identify critical or essential features of the disclosures herein, but instead merely summarizes certain features and variations thereof. Other details and features will also be described in the sections that follow.

Some of the features described herein relate to a system and method for extending a distance over which an imaging system, such as a LIDAR system, can scan targets reliably. In some embodiments, the imaging system can include at least one delay mechanism for delaying a locally generated reference signal with respect to an output signal generated by the imaging system. For example, the LIDAR system may tap a portion of an outgoing LIDAR signal to generate the reference signal that may be delayed in time with respect to the outgoing LIDAR signal by introducing a path delay, such as a delay line, that can increase a distance over which the reference signal needs to traverse before being combined with a returning LIDAR signal for signal processing purposes.

By introducing the delay in the propagation of the local reference signal, the imaging system may extend a duration over which the system can capture and process a return signal that has been reflected-off a scanned object. In some embodiments, the performance of the imaging system with a delayed reference signal may improve due to mitigation of phase noise between the delayed reference signal and the return signal. Additionally, adverse effects of laser chirp non-linearities, laser phase noise, and other signal distortions associated with processing of the delayed reference signal and the received LIDAR signal may reduce thereby improving a signal-to-noise ratio associated with the beat signal. Accordingly, the imaging system may generate imaging information associated with a distance and/or velocity of a scanned target with increased accuracies over longer imaging distances.

In some embodiments, the reductions in the phase noise and other signal non-linearities may allow for a more accurate system performance with less stringent specification metrics and/or reduced performance associated with a light source, such as the laser. For example, some features described herein may enable the imaging system to accurately determine distance and/or velocity information of the target over a longer range (e.g., over 200 meters) without an increase in power and/or decrease in a linewidth of the transmitted output signal. This can enable the design of such three-dimensional imaging systems at reduced costs.

### BRIEF DESCRIPTION OF THE DRAWINGS

Some features herein are illustrated by way of example, and not by way of limitation, in the figures of the accompanying drawings and in which like reference numerals refer to similar elements.

FIG. 1 shows a schematic illustration of various components of a LIDAR chip in accordance with various embodiments described herein.

FIG. 2 shows a schematic illustration of electronics, control, and processing circuitry interfacing with a portion of the LIDAR chip of FIG. 1 in accordance with various embodiments described herein.

FIG. 3 shows a schematic illustration of a modified LIDAR chip configured to receive multiple different LIDAR input signals in accordance with various embodiments described herein.

FIG. 4 shows a schematic illustration of the modified LIDAR chip of FIG. 3 with an amplified output in accordance with various embodiments described herein.

FIG. 5 shows a schematic illustration of a LIDAR adapter in accordance with various embodiments described herein.

FIG. 6 shows a schematic illustration of a LIDAR adapter for use with a LIDAR system providing polarization compensation in accordance with various embodiments described herein.

FIG. 7 shows a schematic illustration of a LIDAR adapter that includes passive optical components and is suitable for use with a LIDAR system providing polarization compensation in accordance with various embodiments described herein.

FIG. 8A shows a plot of frequency versus time for imaging signals associated with an exemplary LIDAR system in accordance with various embodiments described herein.

FIG. 8B shows a plot of frequency versus time for imaging signals associated with a LIDAR system configured to delay the reference signal in accordance with various embodiments described herein.

FIG. 9 illustrates an exemplary flowchart in accordance with various embodiments described herein.

### DETAILED DESCRIPTION

Example embodiments will now be described more fully with reference to the accompanying drawings. Many alternate forms may be embodied, and example embodiments should not be construed as limited to example embodiments set forth herein. In the drawings, like reference numerals refer to like elements.

It will be understood that, although the terms first, second, etc. may be used herein to describe various elements, these elements should not be limited by these terms. As used herein, the term “and/or” includes any and all combinations of one or more of the associated items. Unless specifically stated otherwise, or as is apparent from the discussion, terms such as “processing” or “computing” or “calculating” or “determining” or “displaying” or the like, refer to the action and processes of a computing system, or similar electronic computing device, that manipulates, and transforms data represented as physical, electronic quantities within the computing system's registers and memories into other data similarly represented as physical quantities within the computing system's memories or registers or other such information storage, transmission or display devices.

In the following description, illustrative embodiments will be described with reference to symbolic representations of operations (e.g., in the form of flow charts, flow diagrams, data flow diagrams, structure diagrams, block diagrams, etc.) that may be implemented as program modules or functional processes including routines, programs, objects, components, data structures, etc. that perform particular tasks or implement particular abstract data types and may be implemented using hardware in electronic systems (e.g., an imaging and display device). Such existing hardware may include one or more digital signal processors (DSPs), application-specific integrated circuits (ASICs), field programmable gate arrays (FPGAs), central processing units (CPUs), or the like.

As disclosed herein, the term “storage medium,” “computer readable storage medium” or “non-transitory computer readable storage medium” may represent one or more devices for storing data, including read only memory (ROM), random access memory (RAM), magnetic RAM, magnetic disk storage memory, optical storage mediums, flash memory devices and/or other tangible machine readable mediums for storing information. The term “computer-readable memory” may include, but is not limited to, portable or fixed storage devices, optical storage devices, and various other mediums capable of storing, containing or carrying instructions and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. When implemented in software, a processor(s) may be programmed to perform the necessary tasks, thereby being transformed into special purpose processor(s) or computer(s).

The LIDAR system may include a LIDAR chip for generating, transmitting, and/or receiving light signals, a scanner, optics, communication interfaces, transducers, electronics, and various processing elements for performing various signal processing functions. In some embodiments, the LIDAR system may include one or more display devices, and/or graphical user interfaces. In some embodiments, the LIDAR system may be based on a Frequency Modulated Continuous Wave (FMCW) mode of operation that may chirp or sweep a frequency of outgoing light that can be referred to as the outgoing LIDAR signal. Accordingly, the frequency of the outgoing LIDAR signal may linearly increase over a first chirp duration, (t₁) and linearly decrease over a second chirp duration (t₂). For example, variations in the frequency of the outgoing LIDAR signal frequency may vary a wavelength of the outgoing LIDAR signal between approximately 1400 nm to approximately 1600 nm over different chirp durations. In some instances, the increase and/or decrease in frequency of the outgoing LIDAR signal is linear.

In some embodiments, one or more of light sources, such as a laser, may be configured to generate the outgoing LIDAR signal with a wavelength centered around approximately 1550 nm. The first chirp duration with the linearly increasing outgoing LIDAR signal frequency may be referred to as an up-ramp and the second chirp duration with the linearly decreasing outgoing LIDAR signal frequency may be referred to as a down-ramp. The LIDAR system may include a local timing reference generator (e.g., local oscillator) that may generate a chirp timing signal indicative of a start of each chirp duration, such as the up-ramp and the down-ramp. Upon reflection by an object, a portion of the outgoing LIDAR signal may be collected by the LIDAR chip as a LIDAR input signal. A portion of the chirped outgoing LIDAR signal may be used as a reference signal for comparing with the LIDAR input signals. The FMCW LIDAR system may estimate a distance and/or velocity of the objects based on a frequency difference between one or more LIDAR input signals and the reference signal.

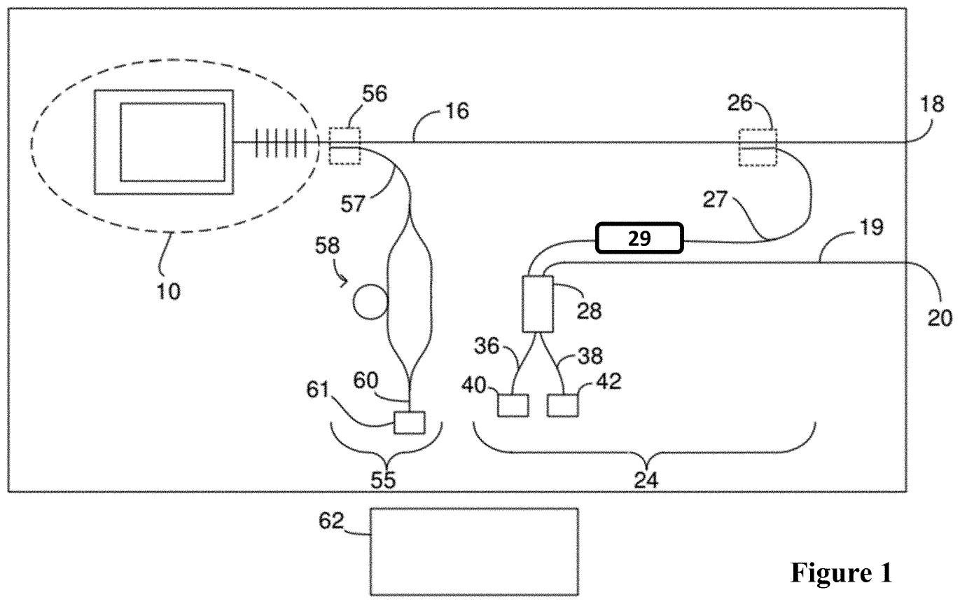

FIG. 1 shows a top view illustration of an exemplary LIDAR chip. In some embodiments, the LIDAR chip may comprise a photonic integrated circuit (PIC) that interfaces with on-board electronics and be referred to as a PIC chip. The electronics may include, but are not limited to, a controller that includes or consists of analog electrical circuits, digital electrical circuits, processors, microprocessors, DSPs, ASICs, FPGAs, CPUs, and/or various combinations designed for performing the operation, monitoring and control functions described above. The controller may be in communication with memory, such as the non-transitory computer readable storage medium described above, that includes instructions to be executed by the controller during performance of the operation, control and monitoring functions. Although the electronics are illustrated as a single component in a single location, the electronics may include multiple different components that are independent of one another and/or placed in different locations. Additionally, as noted above, all or a portion of the disclosed electronics may be included on the chip including electronics that may be integrated with the chip. The electronics may comprise a part of the LIDAR system.

The LIDAR chip can include a light source 10 (e.g., laser). The output of the light source 10 may be coupled into a utility waveguide 16 that terminates at a facet 18 of the LIDAR chip. The waveguide 16 transmits the coupled light output from the light source to the chip facet 18. The light output transmitted from the facet 18 can serve as an outgoing LIDAR signal emitted from the LIDAR chip For example, the facet 18 may be positioned at an edge of the LIDAR chip so the outgoing LIDAR signal traveling through the facet 18 exits the chip and serves as the LIDAR output signal.

The LIDAR output signal travels away from the chip and may be reflected by objects in the path of the LIDAR output signal. When the LIDAR output signal is reflected, at least a portion of the light from the reflected signal may be returned to an input waveguide 19 on the LIDAR chip as a first LIDAR input signal. The first LIDAR input signal includes or consists of light that has been reflected by an object located off the chip in a sample region associated with a field of view of the LIDAR chip while the reference signal does not include light that has been reflected by the object. In some embodiments, when the chip and the reflecting object are moving relative to one another, the first LIDAR input signal and the reference signal may have different frequencies at least partially due to the Doppler effect.

The input waveguide 19 may include a facet 20 through which the first LIDAR input signal can enter the input waveguide 19. The first LIDAR input signal that enters the input waveguide 19 may be referred to as an incoming LIDAR signal or a comparative signal. The input waveguide 19 may transmit the first LIDAR input signal to a light-combining component 28 (e.g., multi-mode interference device (MIMI), adiabatic splitter, and/or directional coupler) that may be a part of a data branch 24 of the LIDAR chip. In some embodiments, the light-combining component 28 may be an MMI device such as a 2×2 MMI device. The functions of the illustrated light-combining component 28 can be performed by more than one optical component.

The data branch 24 may include photonic components that guide and/or modify the optical LIDAR signals for the LIDAR chip. The photonic components of the data branch may include a splitter 26, a reference waveguide 27, the light-combining component 28, a first detector waveguide 36, a second detector waveguide 38, a first light sensor 40, and a second light sensor 42. In some embodiments, the data branch 24 may include an additional delay path 29.

The splitter 26 may transmit a portion of the outgoing LIDAR signal from the utility waveguide 16 into the reference waveguide 27. The illustrated splitter 26 may be an optical coupler that operates as a result of positioning the utility waveguide 16 sufficiently close to the reference waveguide 27 so that a portion of the light from the utility waveguide 16 couples into the reference waveguide 27. However, other signal tapping components, such as y-junctions, optical couplers, and MMIs can be used to couple a portion of the light signal from the utility waveguide 16 into the reference waveguide 27.

The portion of the outgoing LIDAR signal transmitted to the reference waveguide 27 may be referred to as a reference signal. The reference waveguide 27 carries the reference signal to the light-combining component 28. In some embodiments, if the data branch 24 includes the delay path 29, the reference waveguide 27 may transmit the reference signal to the delay path 29, wherein the reference signal may be delayed by a predetermined amount that may vary between 1 nanosecond to tens of nanoseconds. The predetermined amount of delay may be based on at least one of the maximum range of operation, the power of the outgoing LIDAR signal, scanning system parameters, performance parameters of the photonic components, and optical properties of one or more optical components of the LIDAR system. In some embodiments, the maximum range of operation may correspond to 50 meters for short-range operation (e.g, 0 meters to 50 meters), 100 meters for mid-range operation (e.g., 50 meters to 100 meters), and 200 meters for long-range operation (e.g., 100 meters to 200 meters). In some embodiments, the delay may be based on including an optical fiber with a length that is proportional to the predetermined amount of delay in the delay path 29. Various other methods for delaying the reference signal may be employed.

In some embodiments, if the light-combining component 28 is a 2×2 MMI, the first LIDAR input signal and the reference signal may couple into the two inputs of the 2×2 MMI via the input waveguide 19 and the reference waveguide 27 respectively. The two input light signals may then interfere as they travel along the two arms of the MMI resulting in each output of the MMI carrying a combined portion of both the first LIDAR input signal and the reference signal. For example, the output light signal associated with the first arm of the MMI may include a portion of the first LIDAR input signal and a portion of the reference signal. The output light signal associated with the second arm of the MMI may include a remaining portion of the first LIDAR input signal and a remaining portion of the reference signal.

In some embodiments, there may be a phase shift (e.g, 0 to π) between the output light signals of the first arm and the second arm of the MMI. The output light signals associated with the two arms of the MMI may be referred to as a first composite signal and a second composite signal, wherein the first and the second composite signals including portions of the first LIDAR input signal and portions of the reference signal. The first composite signal may couple into a first detector waveguide 36 and the second composite signal may couple into a second detector waveguide 38. The first detector waveguide 36 may then transmit the first composite signal to the first light sensor 40 and the second detector waveguide 38 may transmit the second composite signal to the second light sensor 42.

The first light sensor 40 may then convert the first composite signal into a first electrical signal. The second light sensor 42 may convert the second composite signal into a second electrical signal. For example, the first light sensor 40 and the second light sensor 42 respectively convert the first composite signal and the second composite signal into photodetector currents that vary in time. Examples of the light sensors include photodiodes (PDs), and avalanche photodiodes (APDs).

In some embodiments, the first light sensor 40 and the second light sensor 42 may be configured as balanced photodetectors in a series arrangement to cancel out direct current (DC) components associated with their respective photocurrents. The balanced photodetector configuration can reduce noise and/or improve detection sensitivities associated with the photodetectors.

In some embodiments, the light-combining component 28 need not include light-splitting functionality. As a result, the illustrated light light-combining component 28 can be a 2×1 light-combining component rather than the illustrated 2×2 light-combining component and a single light sensor can replace the first light sensor 40 and the second light sensor 42 to output a single data signal. For example, the illustrated light light-combining component can be a 2×1 MIMI device with two input arms and one output arm. If the light combining component is a 2×1 MMI, the chip can include a single detector waveguide, instead of the first and second detector waveguides, that carries a single composite signal, from the output arm of the 2×1 MMI, to the single light sensor.

The LIDAR chip can include a control branch 55 for controlling operation of the light source 10. The control branch may include a directional coupler 56 that can couple a portion of the outgoing LIDAR signal from the utility waveguide 16 into a control waveguide 57. The coupled portion of the outgoing LIDAR signal transmitted via the control waveguide 57 serves as a tapped signal. In some embodiments, other signal-tapping photonic components, such as y-junctions and/or MMIs, may be used in place of the directional coupler 56 illustrated in FIG. 1.

The control waveguide 57 carries the tapped signal to an interferometer 58 that splits the tapped signal and then re-combines different portions of the tapped signal that are respectively offset in phase with respect to each other. The interferometer 58 may be a Mach-Zhender interferometer (MZI) comprising two unequal arms along which the split-up portions of the input signal travel before re-combining (e.g., interfering) towards the end; however, other interferometer configurations may be used. The interferometer signal output may be characterized by an intensity that is largely a function of the frequency of the tapped outgoing LIDAR signal. For example, the MZI may output a sinusoidal signal characterized by a fringe pattern.

The sinusoidal signal from the interferometer 58 can couple into an interferometer waveguide 60 and can function as an input to a control light sensor 61. The control light sensor 61 may convert the sinusoidal light signal into an electrical signal that can serve as an electrical control signal. Changes to the frequency of the outgoing LIDAR signal will cause changes to the frequency of the control light signal. Accordingly, the frequency of the electrical control signal output from the control light sensor 61 is a function of the frequency of the outgoing LIDAR signal. Other detection mechanisms can be used in place of the control light sensor 61. For example, the control light sensor 61 can be replaced with a balanced photodetector arrangement including two light sensors arranged in series as described earlier with respect to the balanced photodetector arrangement of the first light sensor 40 and the second light sensor 42.

Electronics 62 can operate one or more components on the chip. For instance, the electronics 62 can be in electrical communication with and control operation of the light source 10, the first light sensor 40, the second light sensor 42, and the control light sensor 61. Although the electronics 62 are shown off the chip, all or a portion of the electronics can be included on the chip. For instance, the chip can include electrical conductors that connect the first light sensor 40 in series with the second light sensor 42.

During operation of the chip, the electronics 62 may operate the light source 10 such that the light source 10 emits the outgoing LIDAR signal. In some embodiments, the electronics may control the chirp frequency and/or the chirp duration of the outgoing LIDAR signal as described earlier with respect to FIG. 1. The electronics 62 may operate the LIDAR chip through a series of data cycles, wherein LIDAR data is generated for each (radial distance and/or radial velocity between the LIDAR system and a reflecting object) data cycle. A duration of each data cycle may correspond to the chirp duration of either increasing or decreasing chirp frequency of the outgoing LIDAR signal and thereby, the LIDAR output signal.

In some embodiments, each data cycle may correspond to one or more chirp durations thereby including one or more data periods that respectively correspond to increasing or decreasing chirp frequencies of the outgoing LIDAR signal. For example, one data cycle may correspond to two chirp durations effectively encompassing an up-ramp chirp duration and a down-ramp chirp duration. As another example, one data cycle may correspond to three chirp durations effectively encompassing an up-ramp, down-ramp and another up-ramp chirp duration.

In some instances, the LIDAR system includes one or more mechanisms (e.g., mirrors, micro-electro-mechanical systems (MEMS), optical phased arrays (OPAs), etc.) for steering a direction in which the LIDAR output signal travels away from the LIDAR system. The electronics may operate the one or more mechanisms to aim the LIDAR output signal to scan different sample regions associated with a field of view. The sample regions can each be associated with one of the data cycles and/or each data cycle can be associated with one of the sample regions. As a result, each LIDAR data result can be associated with one of the sample regions in the field of view. Different sample regions may have some overlap or be distinct from one another. For data cycles that include two chirp durations, each sample region may be associated with two chirp durations. For data cycles that include three chirp durations, each sample region may be associated with three chirp durations.

During each data period, the electronics may tune the chirp frequency of the outgoing LIDAR signal. As will be described in more detail below, the electronics can employ output from the control branch in order to control the chirp frequency of the outgoing LIDAR signal such that the chirp frequency of the outgoing LIDAR signal, and consequently the LIDAR output signal, as a function of time is known to the electronics. In some instances, a data cycle includes a first data period, such as a first chirp duration, and a second data period, such as a second chirp duration. During the first chirp duration, the electronics 62 may increase the frequency of the outgoing LIDAR signal and during the second chirp duration the electronics 62 may decrease the frequency of the outgoing LIDAR signal or vice versa.

When the outgoing LIDAR signal frequency is increased during the first chirp duration, the LIDAR output signal travels away from the LIDAR chip and an object positioned in a sample region of a field of view may reflect light from the LIDAR output signal. At least a portion of the reflected light is then returned to the chip via a first LIDAR input signal. During the time that the LIDAR output signal and the first LIDAR input signal are traveling between the chip and the reflecting object, the frequency of the outgoing LIDAR signal may continue to increase. Since a portion of the outgoing LIDAR signal is tapped as the reference signal, the frequency of the reference signal continues to increase. As a result, the first LIDAR input signal enters the light-combining component with a lower frequency than the reference signal concurrently entering the light-combining component. Additionally, the further the reflecting object is located from the chip, the more the frequency of the reference signal increases before the first LIDAR input signal returns to the chip because the further the reflecting object is located, the greater will be the round-trip delay associated with the outgoing LIDAR signal exiting the LIDAR chip as the LIDAR output signal and returning as the first LIDAR input signal. Accordingly, the larger the difference between the frequency of the first LIDAR input signal and the frequency of the reference signal, the further the reflecting object is from the chip. As a result, the difference between the frequency of the first LIDAR input signal and the frequency of the reference signal is a function of the distance between the chip and the reflecting object.

For the same reasons, when the outgoing LIDAR signal frequency is decreased during the second data period, the first LIDAR input signal enters the light-combining component with a higher frequency than the reference signal concurrently entering the light-combining component and the difference between the frequency of the first LIDAR input signal and the frequency of the reference signal during the second data period is also function of the distance between the LIDAR system and the reflecting object.

In some instances, the difference between the frequency of the first LIDAR input signal and the frequency of the reference signal can also be a function of the Doppler effect because a relative movement between the LIDAR system and the reflecting object can also affect the frequency of the first LIDAR input signal. For instance, when the LIDAR system is moving toward or away from the reflecting object and/or the reflecting object is moving toward or away from the LIDAR system, the Doppler effect can affect the frequency of the first LIDAR input signal. Since the frequency of the first LIDAR input signal is a function of the radial velocity between the reflecting object and the LIDAR system, the difference between the frequency of the first LIDAR input signal and the frequency of the reference signal is also a function of the radial velocity between the reflecting object and the LIDAR system. Accordingly, the difference between the frequency of the first LIDAR input signal and the frequency of the reference signal is a function of the distance and/or radial velocity between the LIDAR system and the reflecting object.

The composite signal may be based on interference between the first LIDAR input signal and the reference signal that can occur within the light-combining component 28. For instance, since the 2×2 MMI guides the first LIDAR input signal and the reference signal over two paths in close proximity to each other, and these signals have different frequencies, there is beating between the first LIDAR input signal and reference signal. Accordingly, the composite signal can be associated with a beat frequency related to the frequency difference between the first LIDAR input signal and the reference signal and the beat frequency can be used to determine the difference in the frequency between the first LIDAR input signal and the reference signal. A higher beat frequency for the composite signal indicates a higher differential between the frequencies of the first LIDAR input signal and the reference signal. As a result, the beat frequency of the data signal is a function of the distance and/or radial velocity between the LIDAR system and the reflecting object.

The beat frequencies (f_{LDP}) from two or more data periods or chirp durations may be combined to generate LIDAR data that may include frequency domain information, distance and/or radial velocity information associated with the reflecting object. For example, a first beat frequency that the electronics 62 determine from a first data period (DP₁) can be combined with a second beat frequency that the electronics determine from a second data period (DP₂) to determine a distance of the reflecting object from the LIDAR system and in some embodiments, a relative velocity between the reflecting object and the LIDAR system.

The following equation can apply during the first data period during which the electronics 62 may linearly increase the frequency of the outgoing LIDAR signal: f_{ub}=−f_{d}+ατ, where f_{ub} is the beat frequency, and fa represents the Doppler shift (f_{d}=2vf_{c}/c), wheref_{c} represents the optical frequency (fₒ), c represents the speed of light, ν is the radial velocity between the reflecting object and the LIDAR system where the direction from the reflecting object toward the chip is assumed to be the positive direction. The following equation can apply during the second data period where electronics linearly decrease the frequency of the outgoing LIDAR signal: fat, =−f_{d}−ατ, where f_{db} is the beat frequency. In these two equations, f_{d} and τ are unknowns. The electronics 62 can solve these two equations for the two unknowns. The radial velocity for the reflecting object with the sampled region can then be determined from the Doppler shift (ν=c*f_{d}/(2f_{c})) and the separation distance between the reflecting object in that sampled region and the LIDAR chip can be determined from c*f_{d}/2.

In instances where the radial velocity between the LIDAR chip and the reflecting object is zero or very small, the contribution of the Doppler effect to the beat frequency is essentially zero. In these instances, the Doppler effect may not make a substantial contribution to the beat frequency and the electronics 62 may use the first data period to determine the distance between the chip and the reflecting object.

During operation, the electronics 62 can adjust the frequency of the outgoing LIDAR signal in response to the electrical control signal output from the control light sensor 61. As noted above, the magnitude of the electrical control signal output from the control light sensor 61 is a function of the frequency of the outgoing LIDAR signal. Accordingly, the electronics 62 can adjust the frequency of the outgoing LIDAR signal in response to the magnitude of the control. For instance, while changing the frequency of the outgoing LIDAR signal during a data period, the electronics 62 can have a range of preset values for the electrical control signal magnitude as a function of time. At multiple different times during a data period, the electronics 62 can compare the electrical control signal magnitude to the range of preset values associated with the current time in the sample. If the electrical control signal magnitude indicates that the frequency of the outgoing LIDAR signal is outside the associated range of electrical control signal magnitudes, the electronics 62 can operate the light source 10 so as to change the frequency of the outgoing LIDAR signal so it falls within the associated range. If the electrical control signal magnitude indicates that the frequency of the outgoing LIDAR signal is within the associated range of electrical control signal magnitudes, the electronics 62 do not change the frequency of the outgoing LIDAR signal.

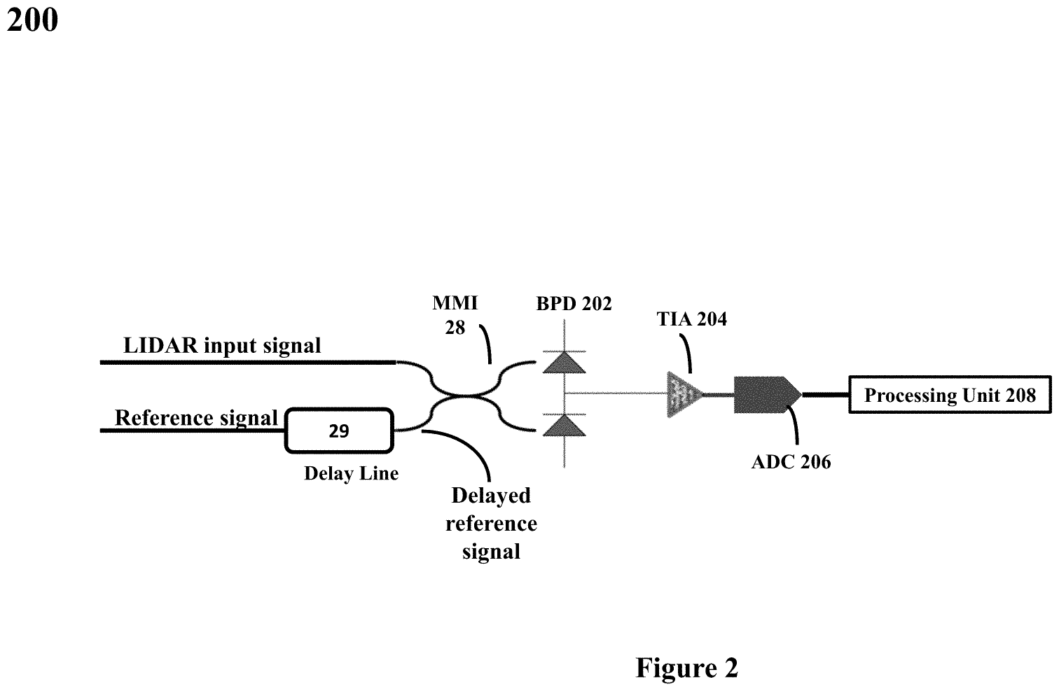

FIG. 2 illustrates an example embodiment of the LIDAR system including the LIDAR chip of FIG. 1 in communication with additional electronic, control, and/or processing circuitry. The LIDAR chip of FIG. 1 may be configured to include the delay line 29, the light combining component 28 (e.g., 2×2 MMI), the balanced photodetector (BPD) 202, and/or a transimpedance amplifier 204 that is electrically connected to an analog-to-digital converter (ADC) 206 and a processing unit 208.

The delay line 29 may be configured to delay the reference signal by the predetermined amount as described earlier with respect to FIG. 1. Accordingly, the LIDAR chip of FIG. 1 may be configured to couple the LIDAR input signal to one input arm of the MMI and delay the locally generated reference signal before coupling the delayed reference signal with the other input arm of the MMI. The MMI may be configured to respectively generate two output signals that may be a function of the interference of the two input signals as described earlier with respect to FIG. 1. The MMI may generate an output signal across each output arm that comprises a direct current (DC) component and an alternating current (AC) component. The AC component may correspond to an optical signal that corresponds to a time-varying electromagnetic signal.

As described earlier, the MMI may generate a combination of both the LIDAR input signal and the delayed reference signal across the two output arms. As such, each output arm of the MIMI may carry a combination of the LIDAR input signal and the delayed reference signal. In some embodiments, the optical signal across one output arm may be shifted in phase with respect to the optical signal on the other output arm. As such, the AC component of the signal on one output arm may be shifted in phase with respect to the AC component of the signal on the other output arm. The phase shift associated with the signals on the output arms of the MIMI may be a function of interference and/or beating of the delayed reference signal and the LIDAR input signal. In some instances, the optical signals across the output arms of the MIMI may be shifted in phase by approximately 180 degrees with respect to each other.

The BPD 202 may receive the two output signals from the output arms of the MIMI and convert the signals into a corresponding electrical signal output. The BPD 202 may be configured to cancel the DC components of the two output signals via the balanced photodetector arrangement while the AC components may be added together to generate the corresponding electrical signal output. The electrical signal output from the BPD 202 may vary in time in proportion to the addition of the AC components of the two optical signals. The output of the BPD 202 may be referred to as the beat signal that is representative of the beating and/or interference between the LIDAR input signal and the delayed reference signal.

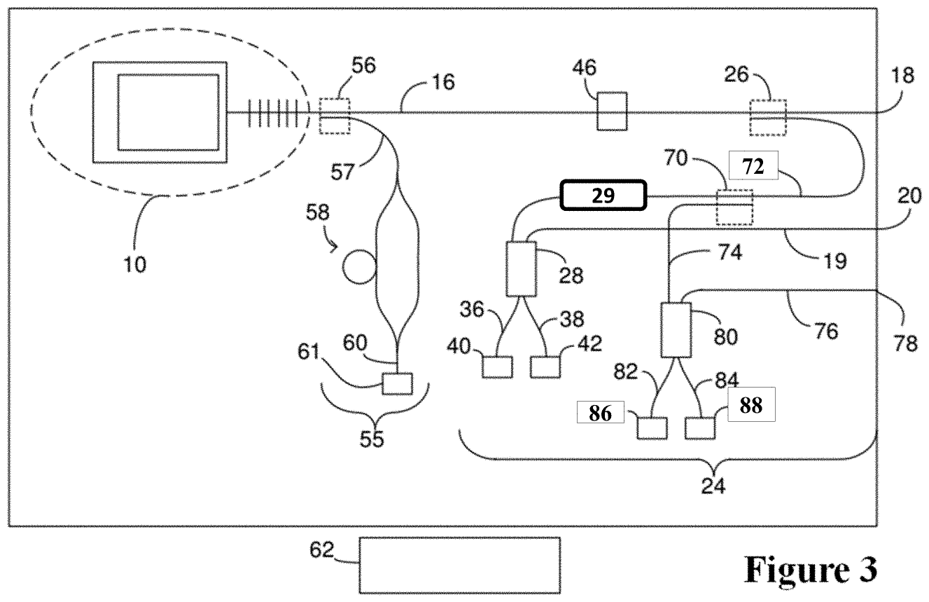

The transimpedance amplifier 204 may be configured to convert the time varying photocurrent output of the balanced photodetector 202 arrangement into a time varying voltage signal or beat signal that has the beat frequency as described above with reference to FIG. 1. According to some embodiments, the beat signal may be largely sinusoidal and may be a function of at least the relative velocity between the LIDAR chip and the reflecting object. For example, if the LIDAR chip and the reflecting object are moving towards each other, the beat signal may increase in frequency and vice-versa. The beat signal can then serve as an input to the ADC 206 that samples the beat signal based on a predetermined sampling frequency to generate a sampled or quantized beat signal output. The predetermined sampling frequency may be based on a maximum range of operation of the LIDAR system. In some instances, the predetermined sampling frequency may be based on the maximum range of operation of the LIDAR system and a maximum relative velocity between the scanned target and the LIDAR chip. In some embodiments, the sampling frequency may vary between 100 MHz and 400 MHz. The sampled beat signal output of the ADC 206 may be electrically connected to the processing unit 208 for estimating the beat frequency as described later with respect to FIGS. 3 to 9.

According to some embodiments, an accuracy of the estimated beat frequency may be based on a number of quantization levels of the ADC 206 that enable sufficiently high signal-to-noise ratios. The LIDAR system may be further configured to generate a point-cloud associated with the three-dimensional image of the reflecting object via at least one display device. The display device may be a part of the LIDAR system and/or a user device configured to communicate with the LIDAR system. In some embodiments, the LIDAR system may include a graphical user interface for user communication and display of the point-cloud.

The balanced photodetector may comprise the light sensors 40 and 42 arranged in series as described above with respect to FIG. 1. The transimpedance amplifier 204 may be included on the LIDAR chip or separate from the LIDAR chip. The ADC 206 may be a discrete component or part of additional processing elements that may comprise a part of the processing unit 208. In alternative embodiments, the 2×2 MMI 28 may be replaced by a 2×1 MMI as described above with respect to FIG. 1. The processing unit 208 may include one or more DSPs, ASICs, FPGAs, CPUs, or the like.

The LIDAR chip of FIG. 1 can be modified to receive multiple LIDAR input signals. For instance, FIG. 3 illustrates the LIDAR chip of FIG. 1 modified to receive two LIDAR input signals via facets 20 and 78. A splitter 70 is configured to divert a portion of the reference signal (i.e., a portion of the LIDAR output signal) carried on a first reference waveguide 72 onto a second reference waveguide 74. Accordingly, the first reference waveguide 72 carries a first reference signal and the second reference waveguide 74 carries a second reference signal.

In some embodiments, the first reference signal may be delayed by the delay line 29 and then carried to the light-combining component 28 and processed by the light-combining component 28 as described in the contexts of FIGS. 1 and 2. Examples of splitters 70 include, but are not limited to, y-junctions, optical couplers, and MMIs.

In some instances, the delay line 29 may be positioned before the splitter 70. In this configuration, the LIDAR chip can be configured to introduce the predetermined amount of delay into the first reference signal carried on the first reference waveguide 72 and the second reference signal carried on the second reference waveguide 74.

The LIDAR output signal travels away from the chip and may be reflected by one or more objects. The reflected signal travels away from the objects and at least a portion of the reflected signal from a first object may enter the LIDAR chip via the facet 20 and at least a portion of the reflected signal from a second object may enter the LIDAR chip via the facet 78. The first LIDAR input signal from facet 20 may be transmitted to the first light-combining component 28 via the first input waveguide 19 and the second LIDAR input from facet 78 may be transmitted to a second light-combining component 80 via a second input waveguide 76. The second input waveguide. The second LIDAR input signal that is transmitted to the second light-combining component 80 acts as a second first LIDAR input signal.

The second light-combining component 80 may combine the second LIDAR input signal and the second reference signal into composite signals that respectively contain a portion of the second LIDAR input signal and a portion of the second reference signal. Each of the composite signals may respectively couple into detector waveguides 82 and 84. The second reference signal includes a portion of the light from the outgoing LIDAR signal. For example, the second reference signal samples a portion of the outgoing LIDAR signal. The second LIDAR input signal may be associated with light reflected by the second object in a field of view of the LIDAR system while the second reference signal is not associated with the reflected light. When the LIDAR chip and the reflecting object are moving relative to one another, the second LIDAR input signal and the second reference signal may have different frequencies at least partially due to the Doppler effect. The difference in the respective frequencies of the second LIDAR input signal and the second reference signal can generate a second beat signal.

In some embodiments, the second reference signal may be delayed before being transmitted to the second light-combining component 80. The delay mechanism may be similar to that of the delay line 29 described earlier with respect to the first reference signal.

The third detector waveguide 82 may carry the respective composite signal to a third light sensor 86 that converts the composite light signal into a third electrical signal. The fourth detector waveguide 84 may carry the respective composite sample signal to a fourth light sensor 88 that converts the composite light signal into a fourth electrical signal.

The second light combining component 80, the associated third light sensor 86 and the associated fourth light sensor 88 can be connected in the BPD arrangement as described earlier with respect to FIGS. 1 and 2 to output a second electrical data signal. Examples of the third and fourth light sensors include avalanche photodiodes and PIN photodiodes.

As described earlier with respect to FIG. 2, the output of the balanced photodetector arrangement of the light sensors 86 and 88 may be coupled to another transimpedance amplifier that is electrically connected to another ADC. The output of the ADC can further serve as an additional input to the processing unit 208 for estimating a second beat frequency associated with the second LIDAR input signal.

The functions of the illustrated second light-combining component 80 can be performed by more than one optical component including adiabatic splitters, directional couplers, and/or MMI devices.

The electronics 62 can operate one or more components on the chip to generate LIDAR outputs signals over multiple different cycles as described above. Additionally, the electronics 62 can process the second electrical signal as described above in the context of FIG. 1. Accordingly, the electronics can generate second LIDAR data results based on the second composite signal and/or LIDAR data results based on the first and second electrical signals. As a result, a single LIDAR output signal can be a function of one or more LIDAR input signals, LIDAR data results, and/or composite signals.

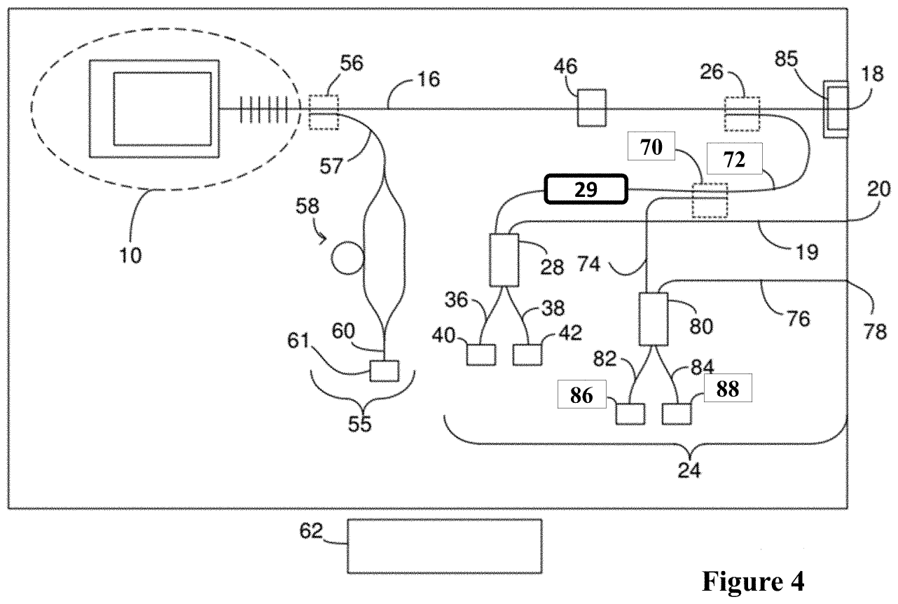

The LIDAR chips can be modified to include other components. For example, FIG. 4 illustrates the LIDAR chip of FIG. 3 modified to include an amplifier 85 for amplifying the LIDAR output signal prior to exiting the LIDAR chip from facet 18. The utility waveguide can be designed to terminate at a facet of the amplifier 85 and couple the light into the amplifier 85. The amplifier 85 can be operated by the electronics 62. As a result, the electronics 62 can control the power of the LIDAR output signal. Examples of amplifiers include, but are not limited to, Erbium-doped fiber amplifiers (EDFAs), Erbium-doped waveguide amplifiers (EDWAs), and Semiconductor Optical Amplifiers (SOAs).

In some embodiments, the amplifier may be a discrete component that is attached to the chip. The discrete amplifier may be positioned at any location on the LIDAR chip along the path of the LIDAR output signal. In some embodiments, all or a portion of the amplifiers may be fabricated as along with the LIDAR chip as an integrated on-chip component. The LIDAR chips may be fabricated from various substrate materials including silicon dioxide, indium phosphide, and silicon-on-insulator (SOI) wafers.

In some embodiments, the LIDAR chips may include at least one attenuator that is configured to attenuate a portion of the light signal reaching the respective light sensor. By varying an amount of attenuation via the attenuator, over saturation of the balanced photodetector may be prevented. The attenuator may be a component that is separate from the chip and then attached to the chip. For instance, the attenuator may be included on an attenuator chip that is attached to the LIDAR chip in a flip-chip arrangement.

In some embodiments, the light sensors may include components that are attached (e.g. manually) to the chips. For example, the light sensors may be connected and/or attached after the LIDAR chips have been fabricated with the integrated photonic components, such as the waveguides, spiltters, couplers, MMIs, gratings, etc. Examples of light sensor components include, but are not limited to, InGaAs PIN photodiodes and InGaAs avalanche photodiodes. In some instances, the light sensors may be positioned on the chip (e.g., centrally) as illustrated in FIG. 1. The light sensors may include the group consisting of the first light sensor 40, the second light sensor 42, the third light sensor 86, the fourth light sensor 88, and the control light sensor 61.

As an alternative to a light sensor that is a separate component, all or a portion of the light sensors may be fabricated as part of the LIDAR chip. For example, the light sensor may be fabricated using technology that is used to fabricate the photonic components on the chip and configured to interface with the ridge waveguides on the chip.

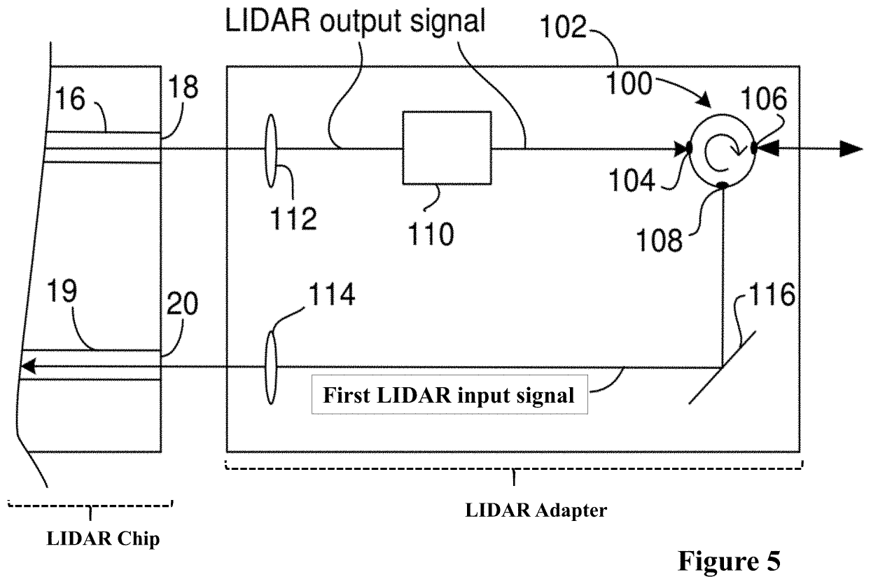

FIG. 5 shows an exemplary configuration of the LIDAR adapter and the LIDAR chip. The LIDAR adapter may be physically and/or optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the first LIDAR input signal and the LIDAR output signal such that the first LIDAR input signal and the LIDAR output signal travel on different optical pathways between the LIDAR adapter and the LIDAR chip but approximately on the same optical pathway between the LIDAR adapter and a reflecting object in the field of view.

The LIDAR adapter may include multiple components positioned on a base. For instance, the LIDAR adapter may include a circulator 100 positioned on a base 102. The illustrated optical circulator 100 can include three ports and is configured such that light entering one port exits from the next port. For example, the illustrated optical circulator includes a first port 104, a second port 106, and a third port 108. The LIDAR output signal enters the first port 104 from the utility waveguide 16 of the LIDAR chip and exits from the second port 106. The LIDAR adapter can be configured such that the output of the LIDAR output signal from the second port 106 can also serve as the output of the LIDAR output signal from the LIDAR adapter. As a result, the LIDAR output signal can be output from the LIDAR adapter such that the LIDAR output signal is traveling toward a sample region in the field of view.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter.

When an object in the sample region reflects the LIDAR output signal, at least a portion of the reflected light travels back to the circulator 100 and enters through the second port 106. The portion of the reflected light that enters the second port 106 may be referred to as the first LIDAR input signal. FIG. 5 illustrates the LIDAR output signal and the first LIDAR input signal traveling between the LIDAR adapter and the sample region approximately along the same optical path.

The first LIDAR input signal exits the circulator 100 through the third port 108 and is directed to the input waveguide 19 on the LIDAR chip. Accordingly, the LIDAR output signal and the first LIDAR input signal travel between the LIDAR adapter and the LIDAR chip along different optical paths.

As is evident from FIG. 5, the LIDAR adapter can include optical components, such as an amplifier 110, lenses 112 and 114, prisms, and mirror 116, in addition to the circulator 100. For example, the adapter of FIG. 4 may include the amplifier 110 positioned so as to receive and amplify the LIDAR output signal before the LIDAR output signal enters the circulator 100. The amplifier 110 can be operated by the electronics 62 allowing the electronics 62 to control the power of the LIDAR output signal. The amplifier 110 may be configured to operate similar to the amplifier 85 described earlier with respect to the LIDAR chip of FIG. 4.

In some embodiments, the LIDAR adapter can include components for directing and controlling the optical path of the LIDAR output signal and the LIDAR input signal such as a first lens 112 and a second lens 114. The first lens 112 can be configured to at least couple, focus, and/or collimate the LIDAR output signal to a desired location. In some embodiments, the first lens 112 may couple the LIDAR output signal from the LIDAR chip onto the first port 104 of the circulator 100 when the LIDAR adapter does not include the amplifier 110. As another example, when the LIDAR adapter includes the amplifier 110, the first lens 112 may focus the LIDAR output signal onto the entry port of the amplifier 110. The second lens 114 may be configured to at least couple, focus and/or collimate the first LIDAR input signal at a desired location. For instance, the second lens 114 can be configured to couple the LIDAR input signal with the input waveguide 19 via the facet 20.

In some embodiments, the LIDAR adapter may include one or more mirrors for changing a respective direction of the LIDAR signals. For example, the LIDAR adapter may include the mirror 116 mirror as a direction-changing component that redirects the LIDAR input signal from the circulator 100 to the facet 20 of the input waveguide 19.

While the LIDAR adapter can include waveguides for guiding the LIDAR signals, the optical path that the LIDAR input signal and the LIDAR output signal travel between components on the LIDAR adapter and/or between the LIDAR chip and a component on the LIDAR adapter can be free space. For instance, the LIDAR input signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the LIDAR input signal and the LIDAR output signal on, to, and from the LIDAR adapter.

The LIDAR system can be configured to compensate for polarization. Light from a laser source is typically linearly polarized and hence the LIDAR output signal is also typically linearly polarized. Reflection from an object may change the angle of polarization of the returned light. Accordingly, the LIDAR input signal can include light of different linear polarization states. For instance, a first portion of a LIDAR input signal can include light of a first linear polarization state and a second portion of a LIDAR input signal can include light of a second linear polarization state. The intensity of the resulting composite signals is proportional to the square of the cosine of the angle between the LIDAR input and reference signal polarization fields. If the angle is 90 degrees, the LIDAR data can be lost in the resulting composite signal. However, the LIDAR system can be modified to compensate for changes in polarization state of the LIDAR output signal.

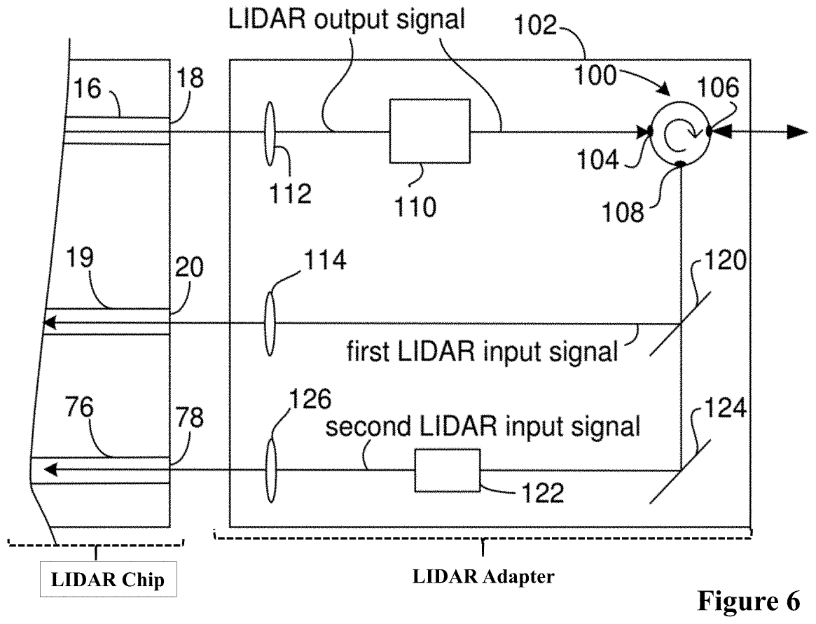

FIG. 6 illustrates an exemplary configuration of a modified LIDAR adapter and the LIDAR chip. The modified LIDAR adapter may include a beamsplitter 120 that receives the reflected LIDAR signal from the circulator 100 and splits the reflected LIDAR signal into a first portion of the reflected LIDAR signal and a second portion of the reflected LIDAR signal. The terms reflected LIDAR signal and LIDAR return signal may be used interchangeably throughout this specification. Examples of beamsplitters include, but are not limited to, Wollaston prisms, and MEMs-based beamsplitters.

The first portion of the LIDAR return signal is directed to the input waveguide 19 on the LIDAR chip and serves as the first LIDAR input signal described in the context of FIG. 1 and FIG. 3 through FIG. 5. The second portion of the LIDAR return signal may be directed to one or more direction changing components 124 such as mirrors and prisms. The direction changing components 124 may redirect the second portion of the LIDAR input signal from the beamsplitter 120 to the polarization rotator 122, the facet 78 of the second input waveguide 76, and/or to the third lens 126. In some embodiments, the second portion of the LIDAR return signal may be directed to the polarization rotator 122. The polarization rotator 122 may outputs the second LIDAR input signal that is directed to the second input waveguide 76 on the LIDAR chip and serves as the second LIDAR input signal described in the context of FIG. 2 through FIG. 4.

The beamsplitter 120 can be a polarizing beam splitter. One example of a polarizing beamsplitter is constructed such that the first portion of the LIDAR return signal has a first polarization state but does not have or does not substantially have a second polarization state and the second portion of the LIDAR return signal has a second polarization state but does not have or does not substantially have the first polarization state. The first polarization state and the second polarization state can be linear polarization states and the second polarization state is different from the first polarization state. For instance, the first polarization state can be TE and the second polarization state can be TM, or the first polarization state can be TM and the second polarization state can be TE. In some instances, the light source may emit linearly polarized light such that the LIDAR output signal has the first polarization state.

A polarization rotator can be configured to change the polarization state of the first portion of the LIDAR return signal and/or the second portion of the LIDAR return signal. For instance, the polarization rotator 122 shown in FIG. 6 can be configured to change the polarization state of the second portion of the LIDAR return signal from the second polarization state to the first polarization state. As a result, the second LIDAR input signal has the first polarization state but does not have or does not substantially have the second polarization state. Accordingly, the first LIDAR input signal and the second LIDAR input signal may each have the same polarization state (the first polarization state in this discussion). Despite carrying light of the same polarization state, the first LIDAR input signal and the second LIDAR input signal are associated with different polarization states of reflected light from an object. For instance, the first LIDAR input signal is associated with the reflected light having the first polarization state and the second LIDAR input signal is associated with the reflected light having the second polarization state. As a result, the first LIDAR input signal is associated with the first polarization state and the second LIDAR input signal is associated with the second polarization state.

Examples of polarization rotators include, but are not limited to, rotation of polarization-maintaining fibers, Faraday rotators, half-wave plates, MEMs-based polarization rotators and integrated optical polarization rotators using asymmetric y-branches, Mach-Zehnder interferometers and multi-mode interference couplers.

Since the outgoing LIDAR signal is linearly polarized, the first reference signal may have the same linear polarization angle as the second reference signal. Additionally, the components on the LIDAR adapter can be selected such that the first reference signal, the second reference signal, the first LIDAR input signal and the second LIDAR input signal each have the same polarization state. In the example disclosed in the context of FIG. 5, the first LIDAR input signals, the second LIDAR input signals, the first reference signal, and the second reference signal can each have light of the first polarization state.

As a result of the above configuration, the first composite signal and the second composite signal can each result from combining a reference signal and a corresponding LIDAR input signal of the same polarization state and will accordingly generate a respective interference between the reference signal and the corresponding LIDAR input signal. For example, the first composite signal may be based on combining a portion of the first reference signal and a portion of the first LIDAR input signal both having the first polarization state while excluding or substantially excluding light of the second polarization state. As another example, the first composite signal may be based on combining a portion of the first reference signal and a portion of the first LIDAR input signal both having the second polarization state while excluding or substantially excluding light of the first polarization state. Similarly, the second composite signal may include a portion of the second reference signal and a portion of the second LIDAR input signal both having the first polarization state while excluding or substantially excluding light of the second polarization state. In another instance, the second composite signal may include a portion of the second reference signal and a portion of the second LIDAR input signal both having the second polarization state while excluding or substantially excluding light of the first polarization state.

In some embodiments, the first composite signal and the second composite signal can each result from combining a delayed reference signal and the corresponding LIDAR input signal of the same polarization state.

The above configurations result in the LIDAR data for a single sample region in the field of view being generated from multiple different composite signals, such as the first composite signal and the second composite signal, associated with the same sample region. In some instances, determining the LIDAR data for the sample region includes the electronics combining the LIDAR data from different composite signals, such as the first composite signal and the second composite signal. Combining the LIDAR data can include taking an average, median, or mode of the LIDAR data generated from the different composite signals. For instance, the electronics can average a distance between the LIDAR system and the reflecting object determined from the first composite signal with a distance determined from the second composite signal and/or the electronics can average the radial velocity between the LIDAR system and the reflecting object determined from the first composite signal with the radial velocity determined from the second composite signal.

In some embodiments, the LIDAR data for a sample region may be determined based on the electronics selecting and/or processing one composite signal out of a plurality of composite signals that may be representative of the LIDAR data associated with the scanned sample region. The electronics can then use the LIDAR data from the selected composite signal as the representative LIDAR data to be used for additional processing. The selected composite signal may be chosen based on satisfying a predetermined signal-to-noise ratio (SNR), a predetermined amplitude threshold, or a dynamically determined threshold level. For example, the electronics may select the representative composite signal (e.g., the first composite signal or the second composite signal) based on the representative composite signal having a larger amplitude than other composite signals associated with the same sample region.

In some embodiments, the electronics may combine LIDAR data associated with multiple composite signals for the same sample region. For example, the processing system may perform a FT on each of the composite signals and add the resulting FT spectra to generate combined frequency domain data for the corresponding sample region. In another example, the system may analyze each of the composite signals for determining respective SNRs and discard the composite signals associated with SNRs that fall below a certain predetermined SNR. The system may then perform a FT on the remaining composite signals and combine the corresponding frequency domain data after the FT. In some embodiments, if the SNR for each of the composite signals for a certain sample region falls below the predetermined SNR value, the system may discard the associated composite signals.

In some instances, the system may combine the FT spectra associated with different polarization states, and as a result, different composite signals, of a same return LIDAR signal. This may be referred to as a polarization combining approach. In some other instances, the system may compare the FT spectra associated with the different polarization states of the same return LIDAR signal and may select the FT spectra with the highest SNR. This may be referred to as a polarization diversity-based approach.

Although FIG. 6 is described in the context of components being arranged such that the first LIDAR input signal, the second LIDAR input signal, the first reference signal, and the second reference signal each have the first polarization state, other configurations of the components in FIG. 6 can be arranged such that the first composite signal results from combining the delayed portion of the first reference signal and the first LIDAR input signal of a first linear polarization state and the second composite signal results from combining the delayed portion of the second reference signal and the second LIDAR input signal of a second polarization state. For example, the beamsplitter 120 may be constructed such that the second portion of the LIDAR return signal has the first polarization state and the first portion of the LIDAR return signal has the second polarization state. The second portion of the LIDAR return signal with the first polarization state then couples into the polarization rotator 122 and undergoes a change in polarization to the second polarization state. The output of the polarization rotator 122 may include the second LIDAR input signal with the second polarization state. Accordingly, in this example, the first LIDAR input signal and the second LIDAR input signal each has the second polarization state.

The above system configurations result in the first portion of the LIDAR input signal and the second portion of the LIDAR input signal being directed into different composite signals. As a result, since the first portion of the LIDAR return signal and the second portion of the LIDAR return signal are each associated with a different polarization state but electronics can process each of the composite signals, the LIDAR system can compensate for changes in the polarization state of the LIDAR output signal in response to reflection of the LIDAR output signal.

The LIDAR adapter of FIG. 6 can include additional optical components including passive optical components. For instance, the LIDAR adapter may include a third lens 126. The third lens 126 can be configured to couple the second LIDAR input signal at a desired location. In some instances, the third lens 126 focuses or collimates the second LIDAR input signal at a desired location. For instance, the third lens 126 can be configured to focus or collimate the second LIDAR input signal on the facet 78 of the second input waveguide 76.

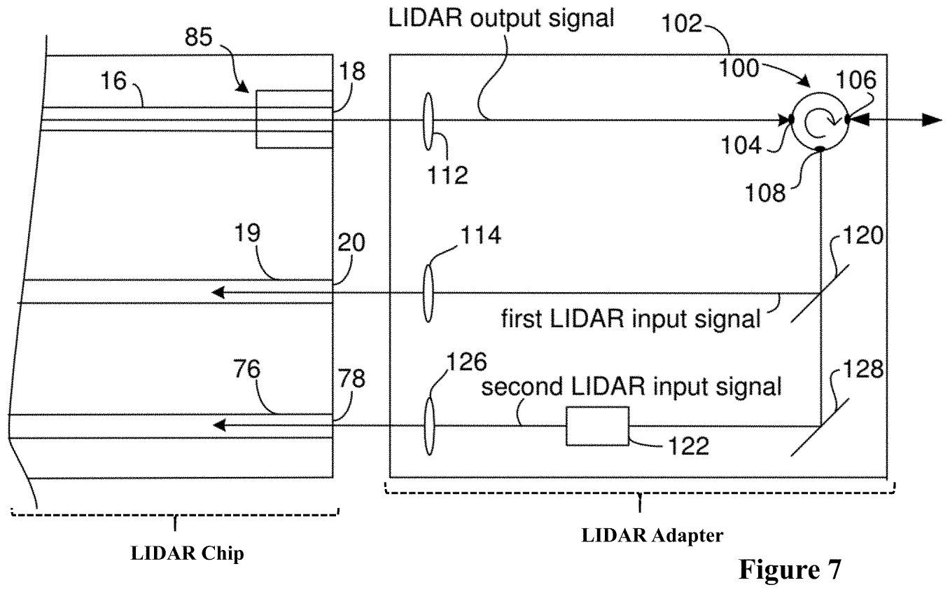

FIG. 7 shows an exemplary illustration of the LIDAR adapter configured for use with the LIDAR chip of FIG. 3 that outputs the amplified LIDAR output signal from amplifier 85. Accordingly, the active components of the LIDAR system, such as the amplifier 85, that are operated by the electronics and/or that provide electrical output to the electronics may be positioned on the LIDAR chip while the passive components, such as the lenses, mirrors, prisms, and beamsplitters, may be located on the LIDAR adapter. As such, in some embodiments, the LIDAR system may include the LIDAR adapter having discrete passive components on the base and the LIDAR chip having a combination of discrete and integrated components. In some other embodiments, the LIDAR system may include the LIDAR adapter having discrete passive components on the base and the LIDAR chip having integrated components (e.g., waveguides, MMIs, and couplers). The discrete components may refer to components that are sourced separately from third parties. The integrated components may refer to the components that are fabricated as part of the LIDAR chip, such as the photonic components.

Although the LIDAR system is shown as operating with a LIDAR chip that outputs a single LIDAR output signal, the LIDAR chip can be configured to output multiple LIDAR output signals. Multiple LIDAR adapters can be used with a single LIDAR chip and/or a LIDAR adapter can be scaled to receive multiple LIDAR output signals.

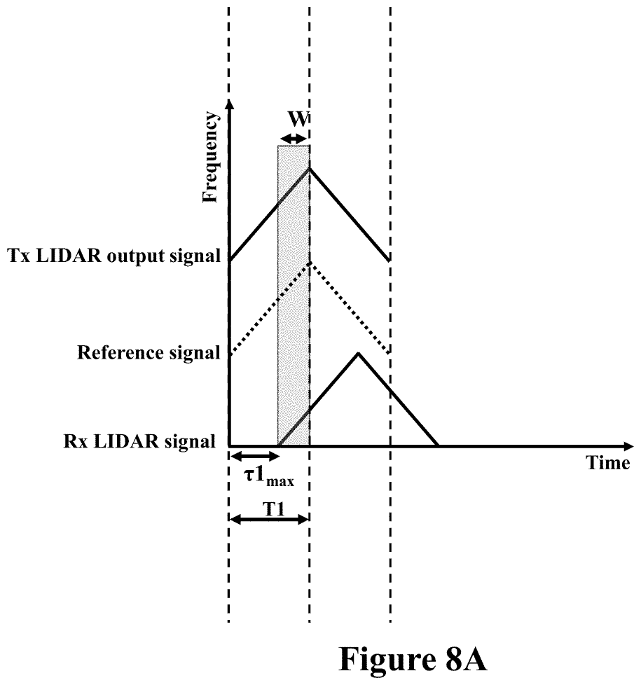

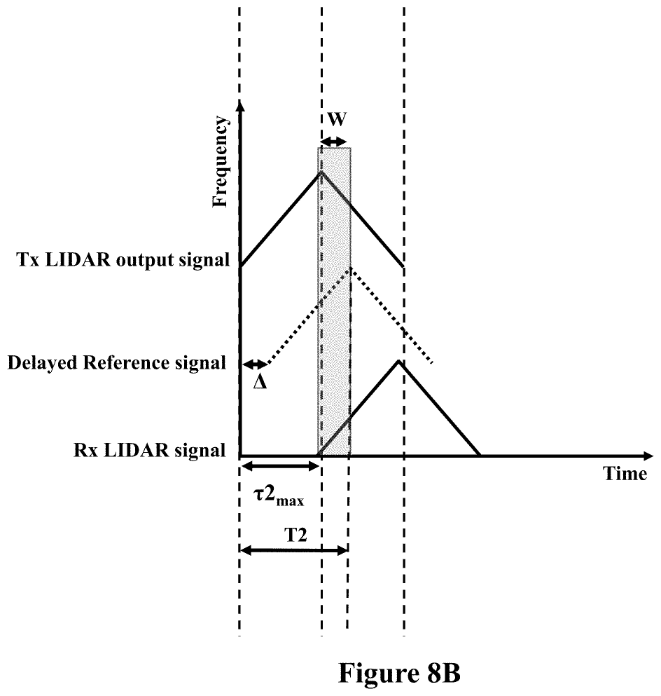

FIGS. 8A-B show an exemplary illustration of the frequency versus time plot of LIDAR signals associated with an exemplary LIDAR system based on a predetermined data capture window duration W and a predetermined chirp duration T1. The data capture window duration and the chirp duration may be determined based on various operating parameters (e.g., range, optical delays within the system, and laser transition periods between chirps) and/or component specifications. For FIGS. 8A-B, the LIDAR system is shown to be based on a data-cycle comprising two chirp durations including an up-chirp and a down-chirp. However, in some embodiments, the LIDAR system may be implemented with a data-cycle comprising less than or more than two chirp durations. For example, the LIDAR system may be based on a data-cycle comprising three chirp durations (e.g., two up-chirps and one down-chirp or vice versa).

FIG. 8A shows an exemplary illustration of a transmitted (Tx) LIDAR output signal, a locally generated reference signal and a received (Rx) LIDAR input signal. The Tx LIDAR output signal and the reference signal of FIG. 8A are synchronized in time with no delay. For the LIDAR system with synchronized output and reference signals, an initial maximum round-trip delay, τ1ₘₐₓ, that can be reliably estimated for a returning LIDAR signal, such as the Rx LIDAR signal, can approximately be equal to a difference between the chirp duration and the width of the data capture window (T1−W). The maximum round-trip delay, τ1ₘₐₓ, may be approximately equal to 2R1ₘₐₓ/c, wherein R1ₘₐₓ is the maximum initial distance at which a target is being scanned and c is the speed of light.

In some embodiments, the down-chirp portions of the LIDAR signals may be associated with the same chirp duration T1 and the data capture window W. In other instances, the down-chirp portions of the LIDAR signals may be associated with a different chirp duration T2 and/or a different data capture window

FIG. 8B shows an exemplary illustration of a Tx LIDAR output signal, a delayed reference signal and a Rx LIDAR signal. The delayed reference signal is delayed in time with respect to the Tx LIDAR output signal by a predetermined delay time (A) that may be based on an extended range of operation and/or a maximum round-trip delay, τ2ₘₐₓ, associated with the extended range of operation. The extended range of operation may include a second maximum distance R2ₘₐₓ at which the target can be scanned. The maximum round-trip delay associated with second maximum distance R2ₘₐₓ may be given by τ2ₘₐₓ=2R2ₘₐₓ/c. By using the delayed reference signal, the LIDAR system can process LIDAR input signals arriving within the extended round-trip delay τ2ₘₐₓ, wherein, (τ2ₘₐₓ−τ1ₘₐₓ)=2(R2ₘₐₓ−R1ₘₐₓ)/c. The LIDAR system may then set the predetermined delay time, A, to approximately equal the difference between the two round-trip delays, i.e. Δ=2(R2ₘₐₓ−R1ₘₐₓ)/c.

For example, the LIDAR system may initially be configured for detecting objects at a maximum range of approximately 200 meters. By delaying the reference signal (e.g., 1 nanosecond to tens of nanoseconds) before generating the beat signal, the LIDAR system can effectively process LIDAR input signals that are received at a later time. Accordingly, the LIDAR system may be able to accurately process LIDAR input signals that are received within an effectively longer duration of T2, wherein T2=(T1+Δ). The maximum round-trip delay that the LIDAR system can reliably measure may be approximately equal to τ2ₘₐₓ=(τ1ₘₐₓ+Δ), wherein τ1ₘₐₓ=(T1−W).

In some embodiments, the delayed reference signal may reduce effects of delay-dependent degradations in the beat signal by reducing a net delay between the delayed reference signal and the Rx LIDAR signal. For example, the net delay between the delayed reference signal and the Rx LIDAR signal may be approximately equal to a difference between a round-trip delay, τ2, and the delay time, Δ, given by (τ2−Δ). In the case of no delay in the reference signal, the net delay between the reference signal and the Rx LIDAR signal would be the round-trip delay time, τ2.

Sources of delay-dependent degradations that can include laser phase noise associated with the Rx LIDAR signal and chirp non-linearities may depend on the total round-trip delay. For longer round-trip delays, the laser phase noise and/or chirp non-linearities may be significantly worse. This in turn can limit the maximum range of operation of the LIDAR system. In some instances, the LIDAR system may need to improve laser performance, such as narrower linewidths and/or increased output power, to mitigate such delay-dependent degradations increasing costs and complexity of the system. For example, improvements in laser performance may increase manufacturing costs associated with the laser. As another example, the system may need to include an optical amplifier in a propagation path of the LIDAR output signal that may also increase system costs. The optical amplifier may be positioned before the output signal exits the LIDAR chip or the LIDAR adapter. Accordingly, LIDAR systems that delay the reference signal before coupling with the Rx LIDAR signal via the light-combining component, can mitigate the delay-dependent degradations by reducing the effective round-trip delay by an amount equal to the predetermined delay time, Δ, and reduce the burden on laser system performance.

In some embodiments, LIDAR systems with the delayed reference signal may improve a signal-to-noise ratio associated with the beat signal. This is because beat signals generated based on a lower time difference between the Rx LIDAR signal and the reference signal can reduce the effects of the laser phase noise and the chirp non-linearities. Accordingly, by delaying the reference signal, the LIDAR system can effectively decrease the time difference between the Rx LIDAR signal and the original reference signal and improve the signal-to-noise ratio of the beat signal. For example, the time difference between the Rx LIDAR signal and the delayed reference signal is reduced by an amount approximately equal to the delay time, A and can be estimated by (τ2−Δ).

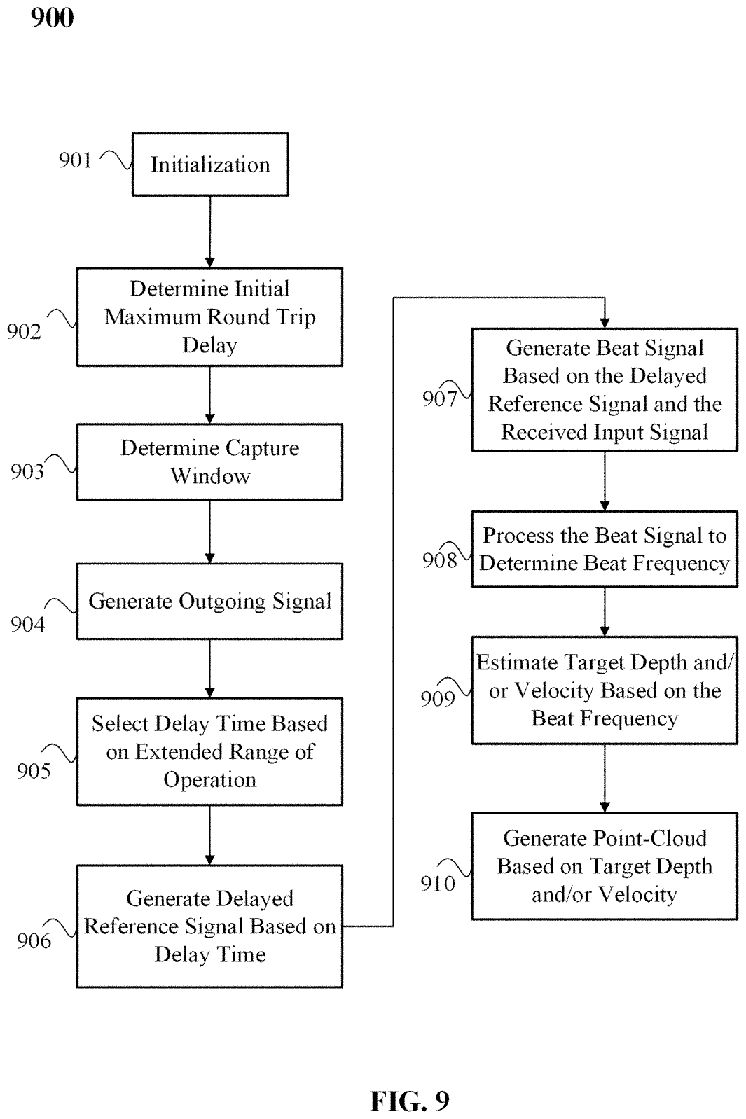

FIG. 9 shows an exemplary flow chart for the LIDAR system based on the delayed reference signal. At 901, the LIDAR system may initialize various parameters such as an initial range of operation, maximum target velocity that may be detected, one or more chirp durations, one or more chirp bandwidths, data cycle pattern(s), data capture window(s), delay time(s), sampling frequencies, and various parameters associated with controlling power levels and/or frequencies of the outgoing LIDAR signal over each chirp duration and/or data cycle. The initial range of operation may include a minimum detection distance and an initial maximum detection distance. The initial range of operation may be based on determining at least one power level of the outgoing LIDAR signal that may be set by controlling laser drive currents. In some embodiments, the initial range of operation may depend on one or more photonic and/or optical components of the LIDAR chip and may be determined by the processing system based on at least one preset value (e.g. field of view, precision, short-term accuracy, and long-term accuracy) associated with the components of the LIDAR system.

In some embodiments, parameters including the sampling frequencies may be selected based on the initial range of operation and the maximum target velocity. Additional parameters including the chirp durations, chirp bandwidths, and outgoing LIDAR power levels may be selected based on a desired performance level.

At least some of the parameters initialized may be associated with delaying the reference signal and/or generating a beat signal with a high signal-to-noise ratio. Additional parameters initialized may be associated with the electronics of the LIDAR chip that may control beat signal sampling rates. The LIDAR system may further initialize parameters associated with estimating a beat frequency corresponding to the beat signal that may provide information associated with target depth and/or velocity.

At 902, the LIDAR system may determine a value of the maximum round-trip delay (e.g., τ1ₘₐₓ of FIG. 8A) associated with the initial maximum detection distance of the LIDAR. As described earlier with respect to FIG. 8A, the maximum round-trip delay corresponding to the initial maximum distance may be estimated based on the following equation: τ1ₘₐₓ=2R1ₘₐₓ/c.

At 903, the LIDAR system may determine at least one value for the data capture window, W, based on the various parameters initialized at 901, such as the corresponding chirp duration and the corresponding chirp bandwidth. The data capture window may further be based on the initial range of operation of the LIDAR system. For example, if the LIDAR system is based on a data-cycle with two chirp durations, the system may further select appropriate values for each of the two chirp durations and corresponding values for the respective data capture widows. In some instances, the LIDAR system may select a value for the chirp bandwidth based on the corresponding values of the chirp duration and the data capture window.

At 904, the system may generate an outgoing signal (e.g., Tx LIDAR signal). The signal power, frequency, modulation, and other parameters of the outgoing signal may be based on one or more parameters initialized at 901. In some embodiments, the outgoing LIDAR signal may be characterized by the chirp duration and the chirp bandwidth described above.

At 905, the system may select an appropriate value of the delay time for delaying the locally generated reference signal. As described earlier with respect to FIG. 1, the system may generate the reference signal based on splitting-off a portion of the outgoing LIDAR signal. The delay time may be determined as described earlier with respect to FIGS. 8A and 8B. For example, the system may determine an extended maximum distance (e.g., R2ₘₐₓ of FIG. 8B) over which targets may be scanned, wherein the new distance is greater than an initial maximum distance over the system could reliably detect the targets. The extended range of operation may now include targets that were located further away and the delay time may correspond to the round-trip time difference associated with the difference between the initial maximum detection distance (e.g., R1ₘₐₓ) and the extended maximum distance (e.g., R2ₘₐₓ). In some embodiments, the system may increase the outgoing LIDAR signal power to enable detection of targets located further away. selected based on one or more parameters including the chirp duration, the chirp bandwidth, the data capture window, outgoing signal power levels, and a desired maximum range of operation of the LIDAR system.

At 906, the system may generate the delayed the reference signal based on the delay time selected. In some embodiments, the system may include an optical switch for switching between different delay lines that may respectively correspond to different delay times.

In some instances, after extending the maximum range of operation, the system may not be able to detect objects located within an initial minimum detection distance. For example, by extending the maximum range of target detection from 200 meters to 250 meters, the system may need to increase a minimum target detection distance from 50 meters to 70 meters. This is because the system may be limited by the delay time (e.g., A) and cannot detect received LIDAR input signals arriving at the LIDAR chip within a round-trip duration that is approximately less than or equal to the delay time introduced.

At 907, the system may generate the beat signal based on an interference between the delayed reference signal and the Rx input signal as described earlier with respect to FIGS. 1 through 8B. At 908, the system may process the beat signal to determine the beat frequency. In some embodiments, the system may utilize data from the beat signal that falls within the data capture window, W, for further processing that may include conversion of the time-varying electrical beat signal into the frequency domain.

As described earlier with respect to FIGS. 1 through 8B, the distance and/or the velocity of the target object can be estimated based on at least the beat frequency, at 909. The system may then generate a three-dimensional point-cloud based on the estimated distances and/or velocities of various scanned objects at 910. For example, as described earlier with respect to FIG. 1, one data cycle may be associated with one or more chirp durations and the system may estimate a beat frequency that corresponds to each chirp duration. Accordingly, the system may use each of the beat frequencies generated during one data cycle to estimate the distance of the target object from the LIDAR chip and the velocity of the target. For example, the system may estimate the velocity associated with the target object based on each of the beat frequencies over one data cycle and the estimated distance of the target.

The system may then generate a three-dimensional image construction of scanned regions based on the point-cloud data that may further be overlaid on two-dimensional images of the scanned regions. The three-dimensional image construction may be displayed by one or more user devices and/or graphical user interfaces in communication with the system.

Although the processing system is disclosed in the context of a LIDAR system, the processing system can be used in other applications such as machine learning, data analytics, autonomous vehicle technology, remote sensing, machine vision, and imaging.

The above-described example embodiments may be recorded in non-transitory computer-readable media including program instructions to implement various operations embodied by a processing system. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer readable media may also be a distributed network, so that the program instructions are stored and executed in a distributed fashion. The program instructions may be executed by one or more processors or computational elements. The non-transitory computer readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents.

1. A remote imaging system comprising:
at least one Light Detection and Ranging (LIDAR) chip configured to:
determine a delay time associated with an extended range of operation, wherein the extended range of operation comprises an extended maximum detection distance;
generate a delayed reference signal based on the determined delay time;
generate an outgoing LIDAR signal for scanning a target located within the maximum detection distance;
receive a LIDAR input signal associated with the target and the outgoing LIDAR signal; and
generate a beat signal based on the delayed reference signal and the received LIDAR input signal; and
a computing device configured to receive the beat signal from the at least one LIDAR chip.

2. The system of claim 1, further comprising control circuitry configured to operate an optical switch.

3. The system of claim 2, wherein the optical switch is configured to select different optical delay lines.

4. The system of claim 2, wherein the optical switch is configured to select an optical delay line that corresponds to the determined delay time.

5. The system of claim 1, wherein the maximum detection distance is associated with at least one of a predetermined field of view, precision value, and an outgoing LIDAR signal power level, and wherein the received LIDAR input signal is associated with a reflected portion of the outgoing LIDAR signal from the target.

6. The system of claim 1, wherein the computing device is further configured to:
select a portion of the beat signal based on a capture window; and
process the portion of the beat signal to determine a beat frequency.

7. The system of claim 6, wherein the computing device is further configured to determine a distance of a target from the LIDAR chip based on the estimated beat frequency, wherein the distance of the target is less than or approximately equal to the maximum detection distance.

8. The system of claim 7, wherein the computing device is further configured to determine a velocity associated with the target based on the estimated beat frequency.

9. The system of claim 8, wherein the computing device is further configured to use the target distance and velocity for generating data associated with a point-cloud construction of the target.

10. The system of claim 9, further comprising a display module configured to display the point-cloud construction of the target.

11. A method for extending a range of operation for a remote imaging system, the method comprising:
estimating a delay time based on a round-trip difference between an initial maximum detection distance and an extended maximum detection distance for an outgoing imaging signal;
delaying a locally generated reference signal based on the delay time;
generating the outgoing imaging signal with an adjusted power level based on the extended maximum detection distance; and
receiving an input imaging signal associated with a scanned target located within the extended maximum detection distance.

12. The method of claim 11, further comprising:
generating a beat signal based on the received input imaging signal and the delayed reference signal.

13. The method of claim 12, further comprising:
selecting a portion of the beat signal based on a capture window; and
determining a beat frequency based on processing the selected portion of the beat signal.

14. The method of claim 13, further comprising:
determining a distance of the target from the imaging system based on the estimated beat frequency.

15. The method of claim 14, further comprising:
determining a velocity associated with the target based on the estimated beat frequency.

16. The method of claim 15, further comprising:
generating data associated with a point-cloud construction of the target based on the target distance and the velocity; and
causing display of the point-cloud construction via a display module.

17. The method of claim 11, wherein the delaying the locally generated reference signal is further based on selecting an optical delay line corresponding to the delay time via an optical switch.

18. The method of claim 17, wherein the optical switch is configured to select different optical delay lines.

19. The method of claim 11, wherein the extended maximum detection distance is associated with at least one of a predetermined field of view, precision value, and a power level for the outgoing imaging signal, and wherein the received imaging signal is associated with a reflected portion of the outgoing imaging signal from the target.

20. The method of claim 11, wherein the received input imaging signal is associated with a predetermined chirp frequency and a predetermined chirp bandwidth.
